(19) United States
(12) Patent Application Publication
(10) Pub. No.: US 2007/0223178 A1
(43) Pub. Date: Sep. 27, 2007

(54) Electric double layer capacitor

(75) Inventor: Takeshi Fujino, Wako-shi (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/714,146

(22) Filed: Mar. 6, 2007

(30) Foreign Application Priority Data
Mar. 27, 2006 (JP) 2006-085502

(51) Int. Cl. H01G 9/00

(52) U.S. Cl. 361/502

(57) ABSTRACT

A double layer capacitor comprises a positive electrode, a negative electrode made of an activated carbon, a separator provided between a positive electrode and a negative electrode, and a nonaqueous electrolysis solution. The positive electrode comprises an alkaline metal complex oxide or an alkaline earth metal complex oxide contained in the activated carbon in a range of from 5 to 40 wt %, and the electrolysis solution comprises an alkaline metal ion or an alkaline earth metal ion in a range of not more than 0.085 mol/l.

### BACKGROUND OF INVENTION

1. Technical Field

The present invention relates to electric double layer capacitors having superior durability and voltage endurance.

2. Background Art

Electric double layer capacitors have wide usable temperature ranges and high power densities. In these double layer capacitors, a nonaqueous electrolysis solution in which a supporting salt such as alkyl ammonium salt is contained in a nonaqueous solvent mainly composed of a cyclic carbonate such as propylene carbonate (PC) is widely used. When an electrolysis solution which mainly contains the propylene carbonate is applied to a double layer capacitor, a gas is generated by gradual decomposition of the electrolysis solution when voltage and temperature are increased. This generated gas causes several kinds of problems because the internal pressure of the capacitor is increased. Therefore, it is difficult for conventional electric double layer capacitors to be used at 3.0 volts or more. In order to improve energy density, high voltage endurance is required.

In order to increase voltage endurance of a double layer capacitor, Japanese Unexamined Patent Publication No. 2000-124081 discloses a method in which operating potential is shifted toward the negative side by using a negative electrode in which a layer composed of an activated carbon doped with lithium is formed on a collector.

However, doping the activated carbon of the negative electrode with lithium is greatly affected by the crystal structure of the carbon. Therefore, it is difficult to obtain enough potential shift by activated carbons which are made from isotropic carbon materials of which the raw materials are inexpensive coconut husk or phenol resin. Therefore, the potential of a negative electrode cannot be sufficiently controlled in the doping.

Japanese Unexamined Patent Publication No. 2003-92104 discloses a double layer capacitor in which a part of a positive or negative electrode surface is covered or adhered with organic capacitor materials of the pseudo-capacitance type which provides capacitance by redox type reaction. The electrodes contain lithium complex oxides which absorb or discharge lithium ions and the electrolysis solution includes LiPF₄. Furthermore, Japanese Unexamined Patent Publication No. 2000-138074 discloses a secondary power source in which a positive electrode includes an activated carbon and lithium transition metal oxides and the electrolysis solution contains LiBF₄.

However, in the above structure, absorbance of lithium accompanying charge transfer toward the inside of the activated carbon of the negative electrode is so slow that decrease of negative potential does not actually occur. Therefore, when a voltage of 3.5 volts is applied to the above structure, only solvent decomposition progresses in pores of the activated carbon, whereby the internal resistance thereof is greatly increased, and the above structure cannot be used. Furthermore, absorbance of lithium does not occur when the voltage is applied, whereby lithium easily generates dendrites which cause internal short-circuits and decrease in self-discharge at the negative electrode under high current density discharge and charge environments. Moreover, a structure with low internal resistance cannot be produced because of low conductivity of the electrolysis solution composed of a mixture of salts of lithium ions and quaternary ammonium ions.

Furthermore, the endurance of conventional double layer capacitors is reduced, especially at temperatures of 40° C. or more, when lithium ions are contained above a certain amount in the electrolysis solution. The reason for such a problem is thought to be as follows. If lithium ions are included above a certain amount, reductive decomposition reaction on the surfaces of activated carbon of the negative electrode can easily occur because the decomposition of propylene carbonate is promoted due to interaction of lithium and propylene carbonate. Such reductive decomposition reactions increase the quantity of coulomb consumption at the negative electrode since the potential is not sufficiently reduced, whereby polarization of the positive electrode, which is a counter electrode, is large. As a result, the potential of the positive electrode greatly increases due to the increase of the potential difference between the electrodes, and the oxidation decomposition reaction of propylene carbonate occurs. Therefore, the rise of the internal resistance increases and a large amount of gas is produced, whereby a high voltage cannot be easily applied. On the other hand, when lithium ions are not contained, the reductive decomposition of propylene carbonate is not easily continued. Therefore, this would be desirable at temperatures of 45° C. or more because the potential of the positive electrode is not increased compared to cases using an electrolysis solution including lithium ions.

### SUMMARY OF THE INVENTION

The present invention has been made in view of the above-described circumstances. An object of the present invention is to provide an electric double layer capacitor in which the gas generation by the decomposition of carbonates is inhibited, the durability is improved, and also the voltage endurance is improved.

The present invention provides an electric double layer capacitor comprising a positive electrode and a negative electrode made of an activated carbon, a separator provided between the positive and negative electrodes, and a nonaqueous solution; wherein the positive electrode comprising an alkaline metal complex oxide or an alkaline earth metal complex oxide contained in the activated carbon in a range of 5 to 40 wt %, and the electrolysis solution comprising an alkaline metal ion or an alkaline earth metal ion in a range of not more than 0.085 mol/L.

In the electric double layer capacitor of the present invention, it is preferable that the alkaline metal complex oxide or alkaline earth metal complex oxide be as shown by chemical formula AMₓO_{y} in which “A” is an alkaline metal or an alkaline earth metal and “M” is a transition metal oxide of which the oxidation number changes. The transition metal “M” is preferably selected from a group consisting of Ti, V, Mn, Fe, Co, Ni, and Al, and the alkaline metal complex oxide or alkaline earth metal complex oxide has particle sizes not larger than that of the activated carbon. Lithium is preferable as an alkaline metal or an alkaline earth metal in the present invention. The nonaqueous electrolysis solution preferably comprises an aprotic solvent consisting of a ester carbonate in the present invention. The separator preferably has a nonwoven fabric in the present invention.

In the double layer capacitor of the present invention, the alkaline metal complex oxide or the alkaline earth metal complex oxide at the positive electrode of the double layer capacitor and the alkaline metal ion or alkaline earth metal ion in the electrolysis solution are provided in the specific range, whereby gas generation caused by decomposition of carbonates is inhibited, the durability is improved, the energy density is increased, and also the voltage endurance is improved. Moreover, with the structure of the separator using a nonwoven fabric, the deposition of the alkaline metal, producing what are called dendrites in the conventional technology, is inhibited because the alkaline metal ion or the alkaline earth metal ion is very small. Therefore, increase of the internal resistance after long period can be inhibited, and a capacitor with small electric losses is obtained.

### BRIEF DESCRIPTION OF DRAWINGS

FIG. 1 is a potential waveform of charge-discharge at 2.5 volts in a coin type electric double layer capacitor with complex oxides in a positive electrode and a double layer capacitor without complex oxides in a positive electrode.

FIG. 2 is a graph showing a relationship between amount of gas generated by decomposition of a solvent and amount of complex oxides.

FIG. 3 is a graph showing a relationship between resistance up rate after durability testing and amount of complex oxides.

FIG. 4 is a graph showing a relationship between variation rate of capacitance and amount of complex oxides.

FIG. 5 is a graph showing a relationship between amount of gas generated by decomposition of a solvent and lithium concentration in an electrolysis solution.

FIG. 6 is a graph showing a relationship between resistance up rate after an endurance testing and lithium concentration in an electrolysis solution.

FIG. 7 is a graph showing a relationship between variation rate of capacitance and lithium concentration in an electrolysis solution.

### EMBODIMENT OF THE INVENTION

The present invention relates to an electric double layer capacitor which comprises; an alkaline metal complex oxide or an alkaline earth metal complex oxide is contained in a range of from 5 to 40 wt % in an activated carbon polarization electrode of a positive electrode of a conventional electric double layer capacitor, and a conventional activated carbon polarization electrode of a negative electrode, wherein an alkaline metal ion or an alkaline earth metal ion such as lithium salts is not contained at more than 0.085 mol/L.

The functions in which the voltage endurance is improved in the invention can be considered to be caused by potential shift of discharge and charge of the electric double layer capacitor, decrease of hydrogen fluoride generated in the activated carbon, and formation of a protective film on the negative electrode. In the electric double layer capacitor of the present invention, the alkaline metal complex oxide of the positive electrode is electrochemically oxidized, and it consumes electric charges because of the increase in the oxidation number at the first charge. For example, in the case of LiNiCoMnO₂, the following reaction occurs.

LiNi_{0.33}Co_{0.33}Mn_{0.33}O₂→Li_{(1-X)}Ni_{0.33}Co_{0.33}Mn_{0.33}O₂+XLi⁺+Xe⁻

Simultaneously, a very small quantity of hydrogen fluoride is generated by charge in pores of the activated carbon of the positive electrode because the anions of electrolytic solution solvent and the adsorbed moisture react as follows

BF₄⁻+H₂O+H⁺→BF₃(OH)+HF

Hydrogen fluoride generated in the reaction reacts as follows, whereby the durability of the activated carbon with the conventional capacitors is reduced.

HF→H⁺+F⁻

On the other hand, in the present invention, the alkaline metal complex oxide incorporates hydrogen fluoride in discharge and generates lithium fluoride in the following reaction, whereby decomposition of the solvent on the activated carbon of the negative electrode is inhibited because lithium fluoride forms a protective film with adhesion to the surface of the activated carbon particle of the negative electrode.

Li_{(1-X)}Ni_{0.33}Co_{0.33}Mn_{0.33}O₂+Li⁺+HF→

Li_{(1-X)}HNi_{0.33}Co_{0.33}Mn_{0.33}O₂+LiF

Thus, the solvent decomposition reaction in the negative electrode is inhibited and the potential of the negative electrode is decreased along with the potential difference, whereby elevation of the potential of the positive electrode by polarization is slow and the discharge and charge potential of the electric double layer is shifted. Therefore, even if the service voltage is the same as the conventional level, the durability is improved. Furthermore, even if the voltage difference is the higher than the conventional level, the capacitor can be practically used and the energy density can be improved.

In the present invention, the preferable maximum rated voltage is 3.4 volts or less. Specifically, the potential range which practically functions is 4.8 volts vs. Li/Li⁺ or less at the positive electrode. If the potential range is more than 4.8 volts, significant undesirable solvent decomposition of the positive electrode occurs. The minimum voltage of the negative electrode is 1.4 volts vs. Li/Li⁺ or more. If the potential range is less than 1.4 volts, undesirable reductive decomposition of the solvent proceeds and the internal resistance increases. It should be noted that the potential shift is undesirably decreased if the charging current in the first change is large, the maximum charging current with respect to 1000 Faraday capacities is 2 amperes and is set according to the capacitance.

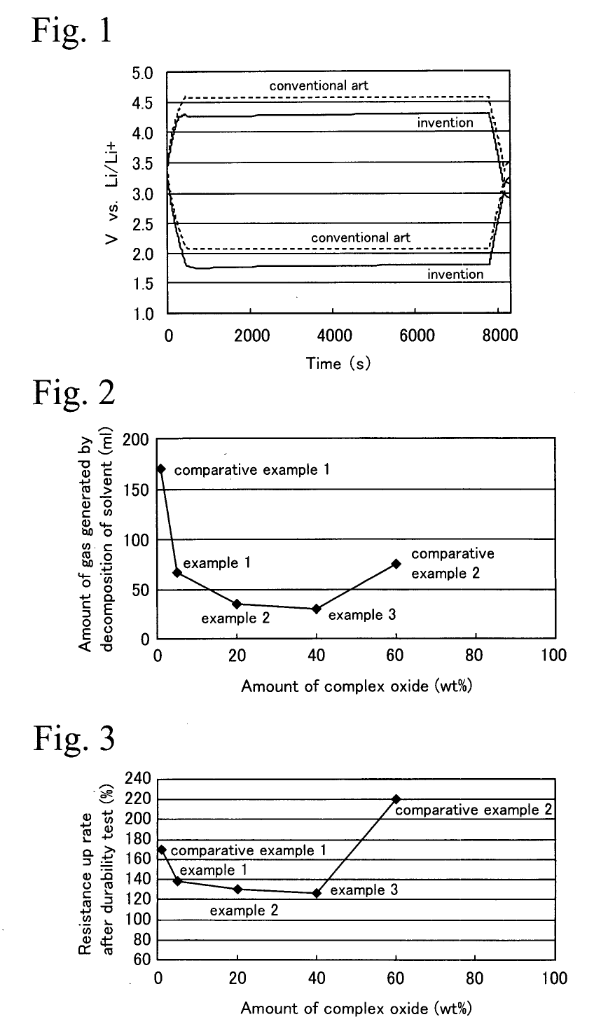

The shift of the discharge and charge potential of the electric double layer capacitor of the present invention is clearly shown by the potential waveform in FIG. 1. A coin type electric double layer capacitor with complex oxide and a double layer capacitor without complex oxide at the positive electrode were prepared. FIG. 1 shows a potential waveform in charge-discharge at 2.5 volts in these capacitors. It should be noted that the potential waveform of the electric double layer capacitor of the present invention is shown as a continuous line and the potential waveform of the electric double layer capacitor of the conventional electric double layer capacitor is shown as a dotted line. As is clearly shown in FIG. 1, it is confirmed that the discharge and charge potential is shifted toward the negative side at about 250 mV.

In the present invention, along with not generating the decomposition reaction of the electrolysis solution at the negative electrode as stated above, the concentration of the alkaline ion metal or the alkaline earth metal ion in the electrolysis solution is held low, so that the potential shift is properly maintained and the internal resistance does not increase.

The alkaline metal complex oxide or the alkaline earth metal complex oxide of the present invention is shown by the chemical formula AMₓO_{y} in which “A” represents an alkaline metal or an alkaline earth metal. Specifically, “A” is preferably one or more selected from the group consisting of Li, Na, K, Mg, Ca, Ba, and La. “M” represents a transition metal oxide of which the oxidation number changes by charge. Specifically, “M” is preferably selected one or more from the group consisting of Ti, V, Mn, Fe, Co, Ni, and Al. In these materials, it is more preferable that “A” be Li and “M” be Mn and V. The above complex oxide can also be a single solid solution phase including multiple types or a mixture including multiple oxide crystals of monometallic oxides.

LiCoO₂, LiNiO₂, LiCrO₂, LiVO₂, LiNi_{0.5}Co_{0.5}O₄, LiMn₂O₄, LiMnO₂, Li₄Mn₅O₁₂, LiTiO₂, LiFeO₂, LiRuO₂, LiWO₂, Li₄Ti₅O₁₂, LaMnO₃, LaCrO₃, LiNaMn₂O₄, NaMn₂O₄, Na_{(1-X)}Fe_{(1-X)}Ti_{X}O₄ are exemplified as the above complexes. Furthermore, the above complex oxide preferably has particle sizes from 10 nm to 50 μm, and they preferably are not larger than that of the activated carbon since the static capacitance per electrode volume decreases small even if the dosage is increased.

The complex oxide in the present invention shifts the potential, for instance, even if it is on the positive electrode such as an adhesion layer. In order to effectively inhibit gas generation, a powder of the complex oxide may be mixed in an activated carbon powder in a manufacturing process of the electrode. Furthermore, liquids or colloidal solutions in which the complex oxide particles are dispersed may be added or impregnated so as to contain them in the inside of the electrode. The complex oxide is preferably provided on the surface of the activated carbon particle or between the activated carbon particles in the electrode. Moreover, the complex oxide functions as a filler in a production process of the electrode, whereby formability of the electrode is improved and production efficiency of the electrode is improved in a dry production process of the electrode.

In the present invention, it is essential that the positive electrode include the above complex oxide in a range of from 5 to 40 wt %. When the content of the above complex oxide is less than 5 wt %, the potential shift does not occur because the capacity of the complex oxide is small, and the advantages of the invention cannot be obtained because the absorption of H⁺ is not sufficient. On the other hand, when the content of the above complex oxide is more than 40 wt %, the concentration of lithium ion in the electrolysis solution undesirably increases. Moreover, since the activated carbon in the positive electrode with respect to the quantity of the volume of electrode is small, the forming capacity is decreased and the potential shift is increased, whereby the internal resistance is greatly increased by the solvent decomposition in the negative electrode.

The kind of the activated carbon for the polarized electrode of the present invention is not limited. Cellulose such as from coconut husk, coal, petroleum, coke, steam activated carbon of which raw material is a thermosetting resin such as phenols may be mentioned as gas activated carbons. An alkaline activated carbon as a chemical activated carbon and, especially, a chemical activated carbon of which raw material is easily graphitizable carbon are preferable for their superior effects. The activated carbon preferably has a specific surface area of from 100 to 2500 m²/g. Micropores of less than 2 nm preferably have volumes of from 0.05 to 1.2 mL/g. The activated carbon preferably has particle sizes of from 10 nm to 50 μm. Moreover, if there is too much of the functional group on the surface of the activated carbon, residual water increases and the electrolysis solution is easily decomposed. Therefore, the total amount of the functional group on the surface of the activated carbon is preferably of from 0.01 to 1.0 meq/g.

In the present invention, in order to decrease generation of dendrites by lithium precipitation in charge and discharge and reduce the internal resistance, a nonwoven fabric may be applied as a separator.

The nonaqueous electrolysis solution of the present invention is obtained by dissolving an electrolyte in an aprotic solvent. Chain ester carbonates (for instance, dimethyl carbonate, methylethyl carbonate, diethyl carbonate), cyclic ester carbonates (for instance, ethyl carbonate, 2,3-dimethylethylcarbonate, butylene carbonate), aliphatic carboxylic acid esters such as methylpropionate, and sulfones such as sulfolane, 3-methylsulfolane, and 2,4-dimethylsulfolane are mentioned as an aprotic solvent. Ester carbonates are more preferable in these solvents. An electrolyte anion preferably includes at least F such as BF₄⁻ (tetrafluoroboricacid) and PF₆⁻. On the other hand, the electrolyte cation is preferably an alkylammonium cation such as a quaternary ammonium cation, pyrrolidinium cation, or alkylimidazolium cation. They may be used individually or as a mixture of two or more electrolyte salts.

Electrolytes other than the electrolytes including the alkaline metal ion or the alkaline earth metal ion can be applied to the invention. The concentration of the electrolyte is preferably in a range of from 0.8 to 6.0 mol/L in order to ensure ion content which is necessary for formation of the electric double layer, and in order to obtain sufficient electrical conduction.

Furthermore, the alkaline metal ion or the alkaline earth metal ion in the positive electrode elutes into the electrolysis solution of the present invention. As these ions exist on the carbon surface as LiF or NaF, the ion concentration of the electrolysis solution decreases. The ion content is 0.006 mol/L when the content of the complex oxide of the positive electrode is 5 wt %. The electrolysis solution of the present invention preferably comprises the alkaline metal ion or the alkaline earth metal ion of which the content is less than 0.085 mol/L, and a content of from 0.006 to 0.085 mol/L is more preferable.

As an adding method of the complex oxide of the present invention, a mixing method of a dry or wet process can be used. An activated carbon powder and a complex oxide may be mixed by a mixer or a ball mill in a dry mixing method. In a wet mixing method, a complex oxide which is dispersed in a small amount of water or an organic solvent may be added and mixed with an activated carbon powder. Alternatively, a complex oxide is dispersed and mixed as a slurry which includes an activated carbon, an antacid, and a binder. It should be noted that water may remain in the activated carbon or the electrode even if sufficient drying was performed in the wet mixing method.

The present invention is manufactured into an element, which is inserted into, for example, an aluminum case, such that there is no clearance between the case and the outer periphery of the element, and is sealed in the case by welding terminals connected to the element. The case has a structure into which an electrolysis solution is injected through an injection hole. The element preferably has a spiral structure which can be easily made with optional sizes by adjusting width and length of electrodes and the electrodes in the element can be tightly compacted by coiling the element. The structure of a capacitor cell of the present invention is not limited to the above structure. A stacked element can be made into a cubic or a rectangular parallelepiped cell by stacking electrodes, whereby the volumetric efficiency of the capacitor module which is formed by connecting multiple cells is more improved than that of the cylindrical type. The case for filling the element is not limited, and the volume change in charge and discharge is preferably less than 1%. The material of the case is also not limited, specifically, Al, Ti, Mg, Fe, Cr, Ni, Mn, Ca, Zr, and alloys thereof can be used.

### EXAMPLES

The present invention is further explained by way of Examples.

### 1. Preparation of Electric Double Layer Capacitors

### Examples 1 to 3 and Comparative Examples 1 and 2

LiNi_{0.33}Co_{0.33}O₂ with an average particle size of 5 μm (Mitsubishi Chemical) was used as a complex oxide. Synthetic mesophase pitch was carbonized at 700° C. in a nitrogen flow for one hour, and this was crushed and a graphite carbon material was prepared. The graphite carbon material was alkaline activated by primary treatment at 400° C. in a nitrogen flow for 3 hours and second treatment at 750° C. for 3 hours with solid potassium hydroxide and was sufficiently washed, thereby preparing an alkaline activated carbon. The alkaline activated carbon had a specific surface area of 790 m²/g measured by a nitrogen adsorption method, micro pore volume of 0.34 ml/g measured by a t-plot method, amount of functional group on the total surfaces of the activated carbon of 0.7 meq/g measured by a titration method, potassium amount of 200 ppm in the activated carbon, and an average particle size of 10 μm.

The specific surface area was measured by a nitrogen gas adsorption method after 0.5 g of the activated carbon was deaerated at 200° C. in a vacuum for 6 hours. The volume of pores of which particle sizes were less than 2 nm was measured by a ‘t-plot method’ (B. C. Lippens, J. H. de Boer, J. Catalysis, 4, 319 (1965)). The amount of functional group on the surface of the activated carbon was measured by the method which is described in Hyomen, vol. 34, No. 2 (1996) and Catal. 16, 179 (1966). Specifically, a sample of 2 g of the activated carbon was collected in a 100 ml Erlenmeyer flask, in which 50 ml of N/10 alkaline reagent sodium ethoxide was added, and they were funneled after shaking for 24 hours. The unreacted alkaline reagent was titrated with N/10 hydrochloric acid, and the functional group was quantified. Potassium was quantified by atomic absorption spectrometry with an aqueous solution which comprised an ash obtained by ashing 20 g of the activated carbon at 700° C. for more than 48 hours.

The activated carbon prepared in the above, the complex oxide, a conductive agent (Trade name: Denkablack, produced by Denki Kagaku Kogyo Kabushiki Kaisha), and polytetrafluoroethylene (PTFE) (Trade name: 6J, produced by Dupont-Mitsui Fluorochemicals Company) as a binder were mixed in ratios shown in Table 1, and they were kneaded and rolled, whereby a sheet of the activated carbon electrode for the positive electrode was prepared. A sheet of activated carbon electrode for the negative electrode was also prepared in the same way as the above process except that the complex oxide was not mixed. The thickness of the sheet of each activated carbon electrode was 140 μm.

As an electrolysis solution, propylene carbonate solution (Trade name: KKE-15, produced by Japan Carlit Co.) of (spiro(1,1)-bipyrrolidinium) tetrafluoroborate and propylene carbonate (PC) solution produced by Mitsubishi Chemical were used. The electrolysis solution was prepared in which the concentration of lithium ion was as shown in Table 1 after the electric double layer capacitor was produced. Each amount of moisture in the electrolysis solution was less than 30 ppm measured by the Karl-Fischer method.

The sheet of the activated carbon electrode produced by the above processes for the positive and the negative electrodes was adhered to both surfaces of a sheet-shaped collector of aluminum foil which was 40 μm thick using a conductive adhesive, thereby forming an electrode body. The electrode body was layered on a separator made of nonwoven fabric of polyester which was 90 μm thick, and these were coiled to make an element. The element made from activated carbon of coconut husk was dried at 160° C. and the element made from alkaline activated carbon was dried at 200° C. in a vacuum for 24 hours. These elements were sealed in an aluminum cylindrical case with a diameter of 40 mm and a height of 120 mm, and were impregnated with the electrolysis solution prepared by the above processes in a glove box, whereby an electric double layer capacitor was produced.

TABLE 1

| | Activated | Concentration of lithium ion in |
|---|---|---|
| | carbon:Complex | electrolysis solution |
| | oxide:Conductive | of manufactured electric double |
| | agent:Binder | layer capacitor (mol/L) |
| Example 1 | 85:5:5:5 | 0.006 |
| Example 2 | 70:20:5:5 | 0.019 |
| Example 3 | 50:40:5:5 | 0.045 |
| Example 4 | 50:40:5:5 | 0.065 |
| Example 5 | 50:40:5:5 | 0.085 |
| Example 6 | 65:20:10:5 | 0.015 |
| Comparative | 89:1:5:5 | 0.000 |
| Example 1 | | |
| Comparative | 30:60:5:5 | 0.091 |
| Example 2 | | |
| Comparative | 50:40:5:5 | 0.145 |
| Example 3 | | |
| Comparative | 50:40:5:5 | 0.510 |
| Example 4 | | |
| Comparative | 65:20:10:5 | 0.502 |
| Example 5 | | |

### Examples 4 and 5, and Comparative Examples 3 and 4

In the processes of the electric double layer capacitor in the above examples 1 to 3 and comparative examples 1 and 2, a propylene carbonate solution (Trade name: KKE-15, produced by Japan Carlit Co.) of (spiro(1,1)-bipyrrolidinium) tetrafluoroborate, a propylene carbonate solution of LiBF₄ produced by Mitsubishi Chemical, and a propylene carbonate solution produced by Mitsubishi Chemical were used to produce an electric double layer capacitor in the same way as the above processes except that the electrolysis solution in which the concentration of the lithium ion after the electric double layer capacitor was produced is as shown in Table 1.

### Example 6

In the process of the electric double layer capacitor in the above examples 1 to 3 and comparative examples 1 and 2, an electric double layer capacitor was produced in the same way as the above processes, except that the activated carbon was changed to a steam activated carbon (Trade name: Coconut husk activated carbon YP17, produced by Kuraray Chemical).

### Comparative Example 5

In the process of the electric double layer capacitor in the above examples 4 and 5 and comparative examples 3 and 4, an electric double layer capacitor was produced in the same way as the above process except that the activated carbon was changed to a steam activated carbon (Coconut husk activated carbon YP17, Kuraray Chemical).

### 2. Evaluation of Electric Double Layer Capacitor

The electric double layer capacitor produced in the above processes was discharged to 0 V for 24 hours after CCCV charge was performed in a condition of at 3.0V, 0.25 A, 45° C. for 24 hours. Then, constant-current discharge at 30 A until 1.1V was performed after CCCV charge was performed at 2.7V, 20 A, 25° C. for 10 min, and the initial capacitance was measured by an energy conversion method.

Next, a durability test was performed in such a way that a constant voltage of 3.0 V was applied to the cell for 1000 hours in a constant temperature tank at 45° C. After the durability test, the capacitance of the cell was similarly measured at 25° C., and a relationship between variation of the capacitance after the durability test and initial characteristics was obtained.

Furthermore, the amount of the gas generation was measured as follows. Because the internal pressure of the cell after the test was increased by gas generation, gas in the inside of the cell after the test was collected and amount thereof was regarded as the amount of gas generated when internal pressure returned to atmospheric pressure. The amount of gas was measured at 400 hours and 1000 hours later after the durability test and the amount of gas generated was the total of these measured values.

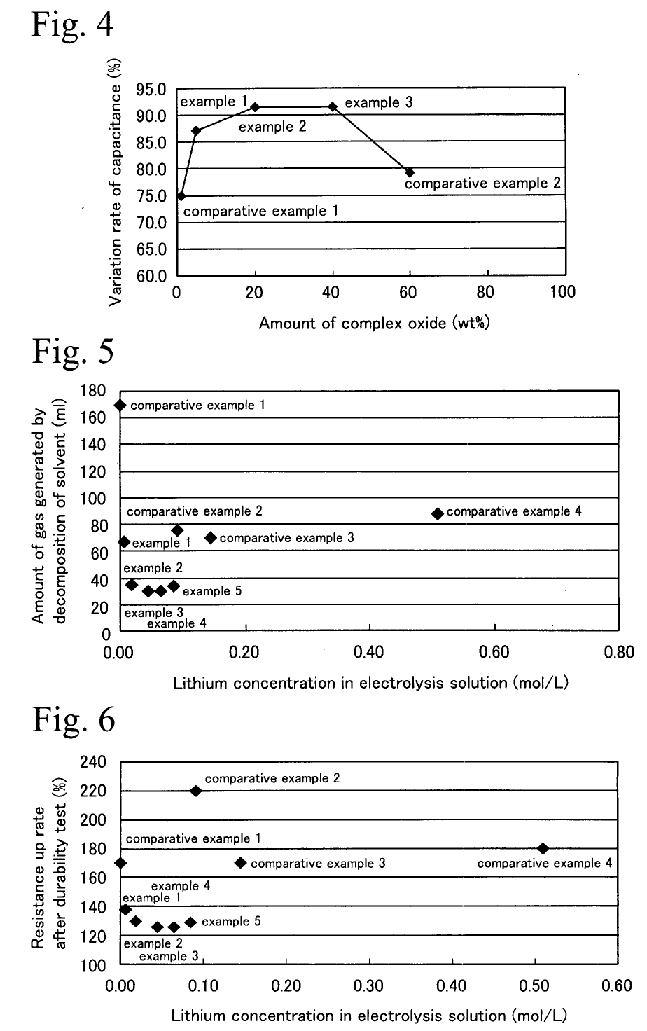

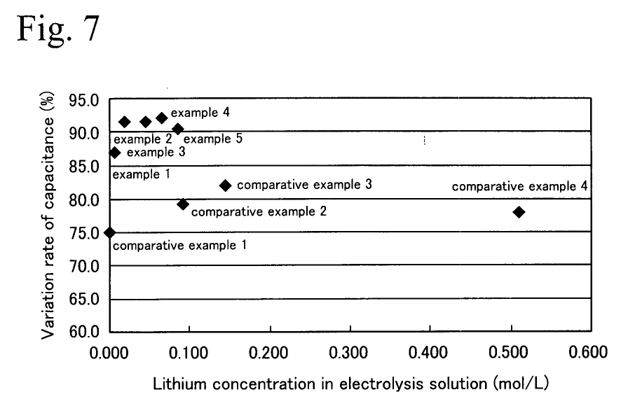

The alkaline metal compound in the electrolysis solution of the capacitor was quantified as follows. The capacitor was discharged to 0 V at 400 hours after starting the durability test. About 6 g of the electrolysis solution in the capacitor was collected in a glove box and was ashed in an electric furnace. Then, this ash was decomposed by heating with nitric acid and hydrofluoric acid and was diluted to a certain quantity with ultra pure water. Thereafter, the amount of this ash was quantified by ICP-AES (Trade name: Optima 4300DV type, produced by PerkinElmer). It should be noted that the amount of lithium ion in comparative example 1 was less than the detection limit. This indicates that the concentration of the lithium ion was less than 5 mmol. The evaluations of the above results are shown in Table 2 and FIGS. 2 to 7.

TABLE 2

| | | | Concentration | | | | | | | |
|---|---|---|---|---|---|---|---|---|---|---|
| | Amount of | | of lithium in | Amount of | Internal resistance | | | Capacitance | | |
| | complex | Concentration | electrolysis | decomposed | Initial | Resistance | Variation | Initial | Capacitance | Variation |
| | oxide | of LiBF₄ | solution | gas | resistance | after test | rate | capacitance | after test | rate |
| | (wt %) | (mol/L) | (mol/L) | (ml) | (mΩ) | (mΩ) | (%) | (F) | (F) | (%) |
| Comparative | 1 | 0 | 0.000 | 170 | 4.20 | 7.14 | 170 | 1969 | 1476 | 75.0 |
| Example 1 | | | | | | | | | | |
| Example 1 | 5 | 0 | 0.006 | 67 | 4.20 | 5.80 | 138 | 1955 | 1701 | 87.0 |
| Example 2 | 20 | 0 | 0.019 | 35 | 3.92 | 5.10 | 130 | 1906 | 1744 | 91.5 |
| Example 3 | 40 | 0 | 0.045 | 30 | 4.26 | 5.36 | 126 | 1829 | 1673 | 91.5 |
| Comparative | 60 | 0 | 0.091 | 75 | 5.60 | 12.32 | 220 | 1757 | 1391 | 79.2 |
| Example 2 | | | | | | | | | | |
| Example 4 | 40 | 0.02 | 0.065 | 30 | 4.30 | 5.42 | 126 | 1829 | 1682 | 92.0 |
| Example 5 | 40 | 0.04 | 0.085 | 34 | 4.47 | 5.76 | 129 | 1820 | 1647 | 90.5 |
| Comparative | 40 | 0.1 | 0.145 | 70 | 4.89 | 8.32 | 170 | 1804 | 1479 | 82.0 |
| Example 3 | | | | | | | | | | |
| Comparative | 40 | 0.5 | 0.510 | 88 | 7.00 | 12.60 | 180 | 1749 | 1364 | 78.0 |
| Example 4 | | | | | | | | | | |
| Example 6 | 20 | 0 | 0.015 | 28 | 2.94 | 4.00 | 136 | 1330 | 1210 | 91.0 |
| Comparative | 20 | 0.5 | 0.502 | 55 | 4.12 | 6.79 | 165 | 1303 | 1082 | 83.0 |
| Example 5 | | | | | | | | | | |

It is clearly shown in Table 2 and FIGS. 2 to 4 that the electric double layer capacitor in examples 1 to 3 which comprised complex oxides in a range of from 5 to 40 wt % in the positive electrode and lithium ion concentration in a range of from 0.006 to 0.045 mol/L in the electrolysis solution had excellent voltage endurance and durability, because the amount of decomposed gas, variation rate of capacitance and internal resistance were small. In contrast, in the electric double layer capacitor in comparative example 1 which comprised complex oxide at 1 wt %, the amount of complex oxide was too small, whereby the amount of decomposed gas was very large and the variation rate of capacitance and internal resistance were large. Furthermore, in the electric double layer capacitor in comparative example 2 which comprised complex oxide at 60 wt % and lithium ion concentration of 0.091 mol/L in the electrolysis solution, potential shift was large and solvent decomposition of the negative electrode proceeded, because the amount of the complex oxide was too large, whereby the initial resistance was large and increase of resistance caused by the durability test was great.

Moreover, it is clearly shown in Table 2 and FIGS. 5 to 7 that the electric double layer capacitor in examples 1 to 4 in which lithium ion concentration was less than 0.085 mol/L in the electrolysis solution had excellent voltage endurance and durability. In contrast, in the electric double layer capacitor in comparative examples 3 and 4 in which the lithium ion concentration was in a range of from 0.145 to 0.510 mol/L in the electrolysis solution, the solvent decomposition in the negative electrode was promoted, amount of decomposed gas was large to some extent, and internal resistance increased because of increase of the lithium ion concentration in the electrolysis solution.

Furthermore, it is clearly shown in Table 2 that in the electric double layer capacitor in example 5 and comparative example 6 in which the activated carbon changed from alkaline activated carbon to steam activated carbon, the same results as mentioned above were obtained, and it was confirmed that the characteristics did not depend on the kind of activated carbon.

What is claimed is:

1. A double layer capacitor comprising:
a positive electrode and a negative electrode made of an activated carbon;
a separator provided between the positive and negative electrodes; and
a nonaqueous electrolysis solution;
the positive electrode comprising an alkaline metal complex oxide or an alkaline earth metal complex oxide contained in the activated carbon in a range of from 5 to 40 wt %; and
the electrolysis solution comprising an alkaline metal ion or an alkaline earth metal ion in a range of not more than 0.085 mol/l.

2. The electric double layer capacitor according to claim 1, wherein the alkaline metal complex oxide or alkaline earth metal complex oxide is shown by chemical formula AMₓO_{y} in which “A” represents an alkaline metal or an alkaline earth metal and “M” represents a transition metal oxide of which oxidation number changes.

3. The electric double layer capacitor according to claim 2, wherein the transition metal “M” is selected from a group consisting of Ti, V, Mn, Fe, Co, Ni, and Al, and the alkaline metal complex oxide or alkaline earth metal complex oxide has particle sizes not larger than that of the activated carbon.

4. The electric double layer capacitor according to claim 2, wherein the alkaline metal or alkaline earth metal is lithium.

5. The electric double layer capacitor according to claim 2, wherein the nonaqueous electrolysis solution comprises an aprotic solvent consisting of a ester carbonate.

6. The electric double layer capacitor according to claim 1, wherein the separator has a nonwoven fabric.

7. The electric double layer capacitor according to claim 1, wherein the capacitor has the maximum rated voltage of the electric double layer capacitor of 3.4 volts or less.

8. The electric double layer capacitor according to claim 1, wherein the activated carbon of the electrodes is an alkaline activated carbon of which a raw material is easily graphitizable carbon.

9. The electric double layer capacitor according to claim 8, wherein the activated carbon of the electrode has a specific surface area of from 100 to 2500 m²/g.

10. The electric double layer capacitor according to claim 8, wherein the activated carbon of the electrode has micropores having volumes in a range of 0.05 to 1.2 mL/g.

11. The electric double layer capacitor according to claim 8, wherein the activated carbon of the electrode has particle sizes of 10 nm to 50 μm.

12. The electric double layer capacitor according to claim 8, wherein the activated carbon of the electrode includes a functional group of which total amount on a surface of the activated carbon is in a range of 0.01 to 1.0 meq/g.

13. The electric double layer capacitor according to claim 1, wherein the nonaqueous electrolysis solution comprises an electrolyte cation consisting of an alkyl ammonium cation at a concentration in a range of 0.8 to 6.0 mol/L.

14. The electric double layer capacitor according to claim 1, wherein the nonaqueous electrolysis solution comprises an alkaline metal ion or an alkaline earth metal ion at a concentration in a range of 0.006 to 0.085 mol/L.

15. The electric double layer capacitor according to claim 1, wherein the capacitor is filled in a case in which volume change in charge and discharge is not more than 1% and is selected from the group consisting of Al, Ti, Mg, Fe, Cr, Ni, Mn, Ca, Zr, and alloys thereof.
